(19) United States
(12) Patent Application Publication
(10) Pub. No.: US 2025/0014773 A1
(43) Pub. Date: Jan. 9, 2025

(54) TEMPORARILY CHANGING THE QUANTIZATION FIELD OF AN ATOMIC OBJECT CONFINEMENT APPARATUS

(71) Applicant: Quantinuum LLC, Broomfield, CO (US)

(72) Inventors: Robert Tyler Sutherland, San Antonio, TX (US); Stephen Erickson, Broomfield, CO (US)

(21) Appl. No.: 18/738,398

(22) Filed: Jun. 10, 2024

Related U.S. Application Data
(60) Provisional application No. 63/525,300, filed on Jul. 6, 2023.

(51) Int. Cl. G21K 1/00; G06N 10/40

(52) U.S. Cl. CPC G21K 1/003; G06N 10/40

(57) ABSTRACT

An atomic object confinement apparatus comprising a plurality of electrodes and one or more quasi-direct-current (quasi-DC) circuits. The plurality of electrodes comprise a plurality of radio frequency (RF) rail electrodes arranged to define, at least in part, a periodic array of confinement segments. The plurality of RF rail electrodes are configured such that, when an oscillating voltage signal is applied thereto, the plurality of RF rail electrodes generate a pseudopotential in a form of an array of trapping regions configured to contain at least one atomic object within a respective trapping region of the array of trapping regions. The one or more quasi-direct-current (quasi-DC) circuits are arranged to generate a magnetic field having a selectable magnitude and a selectable direction, such that the generated magnetic field acts on at least one atomic object within the array of trapping regions.

### CROSS-REFERENCE TO RELATED APPLICATIONS

This application claims priority to and the benefit of U.S. Provisional Patent Application Ser. No. 63/525,300, filed Jul. 6, 2023, and titled “TEMPORARILY CHANGING THE QUANTIZATION FIELD OF AN ATOMIC OBJECT CONFINEMENT APPARATUS,” which is incorporated herein by reference in its entirety.

### TECHNICAL FIELD

Various embodiments relate to quantum computers and methods for temporarily changing magnetic fields of a quantum computer.

### BACKGROUND

Quantum charge-coupled devices (QCCD) architecture is one type of architecture that can be used for large-scale quantum computation. According to QCCD architecture, a plurality of atomic objects (e.g., ions) are confined in a quantum computer by an atomic object confinement apparatus and controlled evolution of the quantum state of the atomic objects is used to perform quantum computations. In various scenarios, the atomic object confinement apparatus may comprise a periodic array of trapping regions. For example, the periodic array of trapping regions may enable the parallelization of various operations such as transport, cooling, or qubit gating.

In some contexts, such an atomic object confinement apparatus has a magnetic field, termed a quantization field or a B-field, which defines the z-axis for the ions. Additionally, in some contexts the electronic transitions that can be driven by the laser(s) or microwave fields that manipulate the atomic objects are determined in part by the effective driving field's polarization direction relative to the quantization field direction-independent of the absolute direction of either set of field. In some contexts, the quantization field is physically set by a constant magnetic field (commonly 2-5 Gauss) pointing in fixed direction relative to the atomic object confinement apparatus. In some contexts, the quantization field is created using permanent magnetics, possibly with external Helmholtz coils added for stabilization. Because such quantization fields are fixed and constant, the magnetic field is the same regardless of which (if any) operation is being performed on the atomic objects.

Through applied effort, ingenuity, and innovation many deficiencies of such quantum object confinement apparatuses and methods of use thereof have been solved by developing solutions that are structured in accordance with the embodiments of the present invention, many examples of which are described in detail herein.

### BRIEF SUMMARY OF EXAMPLE EMBODIMENTS

Example embodiments relate to the quantization field of a quantum computer. Various embodiments relate to temporarily changing the quantization field of a quantum computer. Various embodiments provide one or more quasi-direct-current (quasi-DC) circuits that produce one or more corresponding magnetic fields that interact with a fixed quantization field to produce a customized quantization field. Various embodiments produce a customized quantization field based on an operation to be performed on the quantum computer.

According to a first aspect, an atomic object confinement apparatus is provided. In an example embodiment, the atomic object confinement apparatus comprises a plurality of electrodes and one or more quasi-direct-current (quasi-DC) circuits. The plurality of electrodes comprise a plurality of radio frequency (RF) rail electrodes arranged to define, at least in part, a periodic array of confinement segments. The plurality of RF rail electrodes are configured such that, when an oscillating voltage signal is applied thereto, the plurality of RF rail electrodes generate a pseudopotential in a form of an array of trapping regions configured to contain at least one atomic object within a respective trapping region of the array of trapping regions. The one or more quasi-direct-current (quasi-DC) circuits are arranged to generate a magnetic field having a selectable magnitude and a selectable direction at one or more locations, wherein the generated magnetic field acts on at least one atomic object within the array of trapping regions.

In an example embodiment, the magnitude and the direction of the generated magnetic field are based on a magnitude and a direction of a current flowing through the one or more quasi-DC circuits.

In an example embodiment, the magnitude and the direction of the generated magnetic field are selected based on an operation to be performed.

In an example embodiment, a relatively lower magnitude of the generated magnetic field is selected as a steady-state magnetic field and a relatively higher magnitude of the generated magnetic field is selected when a logical operation is to be performed within the array of trapping regions.

In an example embodiment, the generated magnetic field interacts with a preexisting, fixed magnetic field to create a combined magnetic field.

In an example embodiment, the one or more quasi-DC circuits comprise first and second quasi-DC circuits arranged parallel to each other and a third quasi-DC circuit arranged perpendicularly to the first and second quasi-DC circuits.

In an example embodiment, a first current flowing through the first quasi-DC circuit and a second current flowing through the second quasi-DC circuit in a same direction as the first current generates a magnetic field in a y-direction.

In an example embodiment, a first current flowing through the first quasi-DC circuit and a second current flowing through the second quasi-DC circuit in an opposite direction from the first current generates a magnetic field in a z-direction.

In an example embodiment, a current flowing through the third quasi-DC circuit generates a magnetic field in an x-direction.

In an example embodiment, a current of about 0.1 amps to about 1.0 amp generates a magnetic field of about 4 Gauss to about 40 Gauss at a distance of the at least one atomic object from the one or more quasi-DC circuits.

In an example embodiment, the direction of the generated magnetic field is selected to change a direction of polarization of a manipulation signal-relative to a quantization direction-generated by a manipulation source.

In an example embodiment, each current through a respective one of the one or more quasi-DC circuits ramps up from no current to a desired direct current and ramps down from the desired direct current to no current substantially slower than a Zeeman frequency splitting within a hyperfine manifold associated with the atomic object confinement apparatus.

According to another aspect, a quantum computer is provided. In an example embodiment, the quantum computer comprises an atomic object confinement apparatus as described above.

In an example embodiment, the quantum computer further comprises a voltage source and a controller configured to cause the voltage source to generate the oscillating voltage signal.

According to another aspect, a method is provided. In an example embodiment, the method comprises causing a quantum object confinement apparatus as described above to confine at least one atomic object and generating a magnetic field via one or more quasi-direct-current (quasi-DC) circuits arranged to generate the magnetic field having a selectable magnitude and a selectable direction, wherein the generated magnetic field acts on at least one atomic object within the array of trapping regions.

In an example embodiment, the magnitude and the direction of the generated magnetic field are based on a magnitude and a direction of a current flowing through the one or more quasi-DC circuits.

In an example embodiment, the magnitude and the direction of the generated magnetic field are selected based on an operation to be performed.

In an example embodiment, a relatively lower magnitude of the generated magnetic field is selected as a steady-state magnetic field, and a relatively higher magnitude of the generated magnetic field is selected when a logical operation is to be performed within the array of trapping regions.

In an example embodiment, the generated magnetic field interacts with a preexisting, fixed magnetic field to create a combined magnetic field.

In an example embodiment, the one or more quasi-DC circuits comprise first and second quasi-DC circuits arranged parallel to each other and a third quasi-DC circuit arranged perpendicularly to the first and second quasi-DC circuits.

In an example embodiment, a first current flowing through the first quasi-DC circuit and a second current flowing through the second quasi-DC circuit in a same direction as the first current generates a magnetic field in a y-direction.

In an example embodiment, a first current flowing through the first quasi-DC circuit and a second current flowing through the second quasi-DC circuit in an opposite direction from the first current generates a magnetic field in a z-direction.

In an example embodiment, a current flowing through the third quasi-DC circuit generates a magnetic field in an x-direction.

In an example embodiment, a current of about 0.1 amps to about 1.0 amp generates a magnetic field of about 4 Gauss to about 40 Gauss at a distance of the at least one atomic object from the one or more quasi-DC circuits.

In an example embodiment, the direction of the generated magnetic field is selected to change a relative direction of polarization of a manipulation signal generated by a manipulation source.

In an example embodiment, each current through a respective one of the one or more quasi-DC circuits ramps up from no current to a desired direct current and ramps down from the desired direct current to no current substantially slower than a Zeeman frequency splitting within a hyperfine manifold associated with the atomic object confinement apparatus.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example quantum computing system, according to various embodiments;

FIG. 2 provides a schematic diagram of an example controller of a quantum computer, according to various embodiments;

FIG. 3 provides a schematic diagram of an example computing entity of a quantum computer system that may be used in accordance with an example embodiment;

FIGS. 4A-4G illustrate an example quasi-DC circuit for generating a desired magnetic field in an example quantum computing system, in accordance with an example embodiment; and

FIG. 5 is a flowchart illustrating processes, procedures, and/or operations for generating a desired magnetic field in an example quantum computing system, according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits/tolerances and/or within user measurement capabilities, unless otherwise indicated. Like numbers refer to like elements throughout.

Various embodiments relate to a QCCD-based quantum processor and/or a quantum computer comprising a QCCD-based quantum processor. In general, a QCCD-based quantum processor includes an atomic object confinement apparatus configured to confine atomic objects therein. At least some of the atomic objects are used as the qubits of the quantum processor. Controlled evolution of the quantum state of the atomic objects used as the qubits of the quantum processor enables the quantum processor to perform quantum calculations through the execution of quantum circuits and/or algorithms.

An atomic object confinement apparatus is a device or apparatus used to confine or trap atomic objects. In various embodiments, the atomic object confinement apparatus is manufactured and/or fabricated on a chip (e.g., having a silicon substrate and various electrical components and/or elements fabricated thereon). In various embodiments, the atomic object confinement apparatus is an ion trap (e.g., a surface ion trap, Paul trap, and/or the like).

In various embodiments, an atomic object is an ion; an atom; a neutral, polarized, or ionized molecule; a charged particle; and/or the like, or a group or crystal of ions, atoms, molecules, charged particles, and/or the like.

Various embodiments of the present disclosure enable the quantization field of an atomic object confinement apparatus to be temporarily changed as desired. Having the ability to choose the size and direction of the quantization field enables the quantization field to be customized for one or more of the operations performed in an atomic object confinement apparatus.

In various embodiments, a magnetic field is generated having a selectable magnitude and a selectable direction that acts on at least one atomic object within an array of trapping regions of an atomic object confinement apparatus.

In various embodiments, a magnetic field is generated having a selectable magnitude and a selectable direction that covers a localized region. For example, such a magnetic field could be specific to a gate zone. In various other embodiments, a magnetic field is generated having a selectable magnitude and a selectable direction that covers most or all of an atomic object confinement apparatus.

In various embodiments, one or more quasi-direct-current (quasi-DC) circuits are arranged to generate a magnetic field having a selectable magnitude and a selectable direction. In various embodiments, the magnitude and the direction of the generated magnetic field are based on the magnitude and the direction of the current flowing through the one or more quasi-DC circuits. In various embodiments, the one or more quasi-DC circuits are lithographically printed circuits on the trap chip (i.e., the chip upon which the atomic object confinement apparatus is manufactured and/or fabricated).

In various embodiments, the magnitude and the direction of the generated magnetic field are selected based on an operation to be performed, such as cooling, gating, read out, etc. For example, a relatively lower magnitude of the generated magnetic field may be selected as a steady-state magnetic field, while a relatively higher magnitude of the generated magnetic field may be selected when a logical operation is to be performed within the array of trapping regions. In various embodiments, this may be advantageous because memory errors are reduced and longer memory times are possible with a smaller quantization field magnitude, while logical operations have less leakage with a higher quantization field magnitude.

Generally, the direction of the quantization field relative to the polarization of an effective manipulation signal (e.g., a laser) control what the interaction of the manipulation signal with the atomic object does. In various embodiments, the direction of the generated magnetic field is selected to change a relative direction of polarization of a manipulation signal generated by a manipulation source. This enables passive calibration of the strength of interactions. Instead of changing the polarization of the manipulation signal, the direction of the B-field can be changed to rotate the atomic object's definition of its coordinate system. This is advantageous because is it generally easier to change a current in an integrated circuit (to change the quantization field) than to change the direction of polarization of a laser.

In various embodiments, the generated magnetic field sums with a preexisting, fixed magnetic field (such as is generated by the magnetic field generators described below) to create a combined magnetic field. In various embodiments, the magnitude and the direction of the combined magnetic field are based on the magnitude and the direction of the generated magnetic field and the magnitude and the direction of the preexisting, fixed magnetic field.

### Example Quantum Computer

Various embodiments provide an atomic object confinement apparatus, a quantum processor comprising an atomic object confinement apparatus, a quantum computer comprising an atomic object confinement apparatus, and/or the like and/or methods for use thereby. For example, the atomic object confinement apparatus may confine two or more atomic objects therein. The controlled evolution of the quantum state of one or more of the two or more atomic objects may then be performed (e.g., in accordance with a quantum circuit) using one or more general gates and/or global gates. For example, the atomic object(s) trapped and/or confined by the atomic object confinement apparatus and acted upon by the manipulation signals may be used as qubits of a quantum processor. For example, the quantum computer is configured to perform one or more general gates on two qubits thereof, in various embodiments. For example, the quantum computer is configured to perform one or more individual single-qubit gates generated using at least one two-qubit gate primitive.

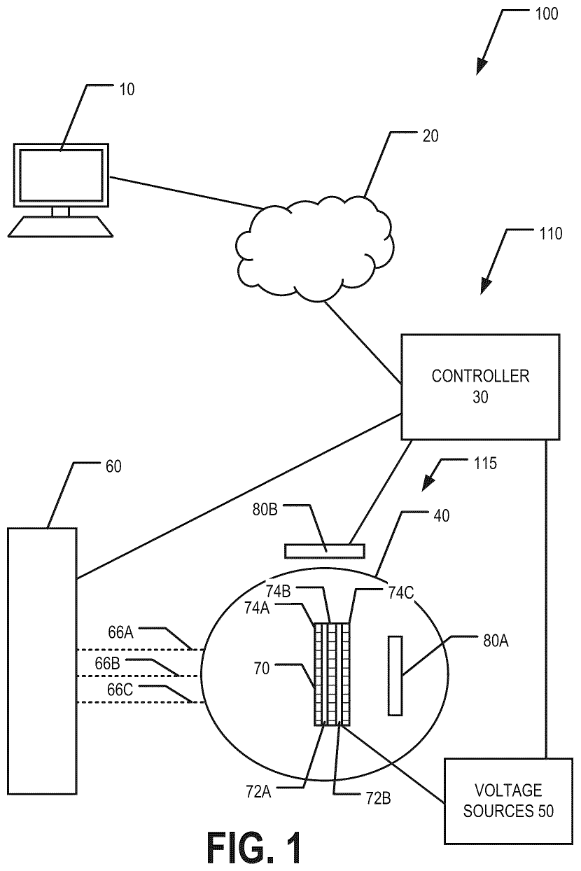

FIG. 1 provides a schematic diagram of an example quantum computer system 100 comprising an atomic object confinement apparatus 70 (e.g., an ion trap, surface trap, Paul trap, and/or the like), in accordance with an example embodiment. In various embodiments, the quantum computer system 100 comprises a computing entity 10 and a quantum computer 110. In various embodiments, the quantum computer 110 comprises a quantum system controller 30 and a quantum processor 115. In various embodiments, the quantum processor 115 comprises an atomic object confinement apparatus 70 enclosed in a cryostat and/or vacuum chamber 40, one or more voltage sources 50, one or more manipulation sources 60, one or more magnetic field generators 80 (e.g., 80A, 80B), and/or the like.

In the illustrated embodiment, the atomic object confinement apparatus 70 comprises radio frequency (RF) rail electrodes 72 (e.g., 72A, 72B) and sequences of trapping and/or transport (TT) electrodes 74 (e.g., 74A, 74B, 74C). In various embodiments, the RF rail electrodes 72 and TT electrodes 74 define a one dimensional atomic object confinement apparatus or a two dimensional atomic object confinement apparatus. Some non-limiting example atomic object confinement apparatuses are described by U.S. Pat. No. 11,037,776, issued Jun. 15, 2021; US Patent Publication No. 2022/0199391, published Jun. 23, 2022; and US Patent Publication No. 2023/0057368, published Feb. 23, 2023, the contents of which are incorporated by reference in their entireties herein.

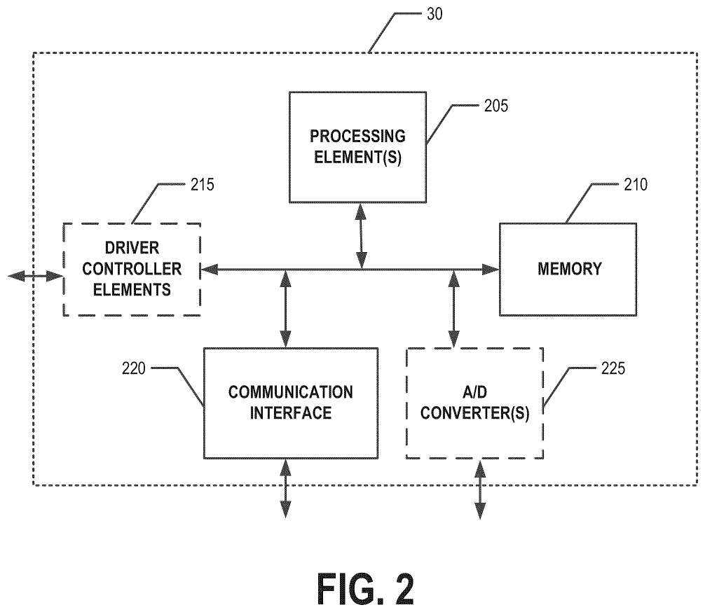

In an example embodiment, the one or more manipulation sources 60 comprise one or more lasers (e.g., optical lasers, microwave sources, and/or the like). In various embodiments, the one or more manipulation sources 60 are configured to manipulate and/or cause a controlled quantum state evolution of one or more atomic objects within the atomic object confinement apparatus 70. For example, the one or more manipulation sources 60 comprise respective manipulation sources 60 configured to generate and provide the first manipulation signal, second manipulation signal, third manipulation signal, fourth manipulation signal, and/or the like. In an example embodiment, at least some of the manipulation signals are laser beams, laser pulse trains, and/or the like. For example, in an example embodiment wherein the one or more manipulation sources 60 comprise one or more lasers, the lasers may provide one or more laser beams to the confinement apparatus within the cryostat and/or vacuum chamber 40 via respective beam/signal delivery systems 66 (e.g., 66A, 66B, 66C). In various embodiments, a beam/signal delivery system 66 comprises one or more optical elements, photonic integrated circuits (PICs), optical fibers, free space optical elements, waveguides, and/or the like. The laser beams may be used to perform various operations (e.g., parallel operations), such as enacting one or more quantum gates on one or more qubits and/or atomic objects, sympathetic cooling of one or more atomic objects, reading a qubit and/or determining a quantum state of an atomic object, initializing an atomic object into the qubit space, and/or the like. In various embodiments, the manipulation sources 60 are controlled by respective driver controller elements 215 (see FIG. 2) of the quantum system controller 30.

In various embodiments, the quantum computer 110 comprises one or more voltage sources 50. For example, the voltage sources 50 may comprise a plurality of TT voltage drivers and/or voltage sources and/or at least one RF driver and/or voltage source. The voltage sources 50 may be electrically coupled to the corresponding potential generating elements (e.g., TT electrodes, RF rail electrodes, RF bus electrodes) of the atomic object confinement apparatus 70, in an example embodiment. For example, the voltage sources 50 are configured to provide (RF) oscillating voltage signals to the RF rail electrodes and RF bus electrodes of the atomic object confinement apparatus 70. For example, the voltage sources 50 are configured to provide controlling voltage signals to the TT electrodes of the sequences of TT electrodes 74. In various embodiments, the voltage sources 50 are controlled by respective driver controller elements 215 of the quantum system controller 30.

In various embodiments, the quantum computer 110 comprises one or more magnetic field generators 80 (e.g., 80A, 80B). For example, the magnetic field generator may be an internal magnetic field generator 80A disposed within the cryogenic and/or vacuum chamber 40 and/or an external magnetic field generator 80B disposed outside of the cryogenic and/or vacuum chamber 40. In various embodiments, the magnetic field generators 80 are permanent magnets, Helmholtz coils, electrical magnets, and/or the like. In various embodiments, the magnetic field generators 80 are configured to generate a magnetic field at one or more regions of the atomic object confinement apparatus 70 that has a particular magnitude and a particular magnetic field direction in the one or more regions of the atomic object confinement apparatus 70. In an example embodiment, the particular magnetic field direction defines the z-direction of the Bloch sphere representation of the qubit. In an example embodiment, the particular magnitude is substantially equal to 5.9 Gauss. In an example embodiment, operation of the one or more magnetic field generators 80 is controlled by the quantum system controller 30. In an example embodiment, at least one of the magnetic field generators 80 is a permanent magnet and therefore is not controlled by the quantum system controller 30.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the quantum system controller 30 of the quantum computer 110 via one or more wired or wireless networks 20 and/or via direct wired and/or wireless communications. In an example embodiment, the computing entity 10 may translate, configure, format, and/or the like information/data, quantum circuits, quantum computing algorithms, and/or the like into a computing language, executable instructions, command sets, and/or the like that the quantum system controller 30 can understand and/or implement.

In various embodiments, the quantum system controller 30 is configured to control the voltage sources 50, cryogenic system and/or vacuum system controlling the temperature and pressure within the cryostat and/or vacuum chamber 40, manipulation sources 60, magnetic field generators 80, and/or other systems controlling various environmental conditions (e.g., temperature, pressure, and/or the like) within the cryostat and/or vacuum chamber 40 and/or configured to manipulate and/or cause a controlled evolution of quantum states of one or more atomic objects within the atomic object confinement apparatus 70. For example, the quantum system controller 30 may cause a controlled evolution of quantum states of one or more atomic objects within the atomic object confinement apparatus 70 to execute a quantum circuit and/or algorithm. For example, the quantum system controller 30 is configured to execute a quantum circuit comprising one or more general gates and/or one or more global gates, in various embodiments.

In various embodiments, the atomic objects confined within the atomic object confinement apparatus 70 are used as qubits of the quantum computer 110 and/or quantum processor 115. For example, the quantum processor 115 may include a plurality of multi-atomic object crystals that each comprise a first atomic object used as a qubit atomic object of the quantum processor (embodying a qubit of the quantum processor 115) and a second atomic object used as a sympathetic cooling atomic object for use in cooling the qubit atomic object of the same multi-atomic object crystal.

### Example Quantum System Controller

In various embodiments, a quantum computer 110 comprises a quantum system controller 30 and a quantum processor 115. The quantum system controller 30 is configured to control various components of a quantum processor 115. For example, various embodiments are configured to perform one or more quantum error corrections for one or more data qubits in real-time and/or near real-time with respect to the occurrence of one or more quantum errors experienced by the one or more data qubits, which may be evaluated as a conditional block.

In various embodiments, the quantum system controller 30 is in communication with an optics collection system such that the quantum system controller 30 is configured to receive input data captured and/or generated by the optics collection system. The quantum system controller 30 is further configured to perform quantum error correction via a software-based correction and/or via the physical application of a quantum error correction to one or more qubits (e.g., by controlling of one or more voltage sources 50 and/or manipulation sources 60). In various embodiments, the quantum system controller 30 is further configured to control a cryostat system and/or vacuum system controlling the temperature and pressure within the cryostat and/or vacuum chamber 40, cooling system, and/or other systems controlling the environmental conditions (e.g., temperature, humidity, pressure, and/or the like) within the cryostat and/or vacuum chamber 40.

As shown in FIG. 2, in various embodiments, the quantum system controller 30 may comprise various quantum system controller elements including processing element(s) 205, memory 210, driver controller elements 215, a communication interface 220, analog-digital (A/D) converter(s) 225, and/or the like. In various embodiments, the quantum system controller 30 is configured to receive input data generated by the optics collection system via the A/D converter(s) 225. In various embodiments, the processing element(s) 205 are configured to operate as described herein. In various embodiments, the quantum system controller 30 may include additional quantum system controller elements as described herein.

In various embodiments, the processing element(s) 205 comprise processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing elements and/or circuitry, and/or the like. The term circuitry may refer to an entirely hardware embodiment or a combination of hardware and computer program products. In an example embodiment, a processing element 205 of the quantum system controller 30 comprises a clock and/or is in communication with a clock.

In various embodiments, the memory 210 comprises non-transitory memory such as volatile and/or non-volatile memory storage such as one or more of hard disks, ROM, PROM, EPROM, EEPROM, flash memory, MMCs, SD memory cards, memory sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 210 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized quantum system controller language(s), and/or the like), and/or the like. In an example embodiment, execution of at least a portion of the computer program code stored in the memory 210 (e.g., by a processing element 205) causes the quantum system controller 30 to perform one or more steps, operations, processes, procedures and/or the like for generating one or more sets of commands configured to cause the quantum processor 115 to perform at least a portion of a quantum circuit; to update one or more qubit registries; and/or the like. In an example embodiment, execution of at least a portion of the computer program code stored in the memory 210 causes the quantum system controller 30 to cause one or more commands to be performed.

In various embodiments, the driver controller elements 215 include one or more drivers and/or quantum system controller elements each configured to control one or more drivers. In various embodiments, the driver controller elements 215 may comprise drivers and/or driver controllers. For example, the driver controllers may be configured to cause one or more corresponding drivers to be operated in accordance with executable instructions, commands, and/or the like generated, scheduled. and executed by the quantum system controller 30. For example, the processing element 205 may generate one or more commands to be performed by a first driver.

In various embodiments, the driver controller elements 215 enable the quantum system controller 30 to operate voltage sources 50, manipulation sources 60, cooling systems, vacuum systems, and/or the like. In various embodiments, the drivers may be laser drivers (e.g., configured to operate and/or control one or more manipulation sources 60); vacuum component drivers; drivers for controlling the flow of current and/or voltage applied to electrodes (e.g., configured to operate and/or control one or more voltage sources 50) used for maintaining and/or controlling the trapping potential of the confinement apparatus 120 (and/or other drivers for providing driver action sequences to potential generating elements of the confinement apparatus); cryostat and/or vacuum system component drivers; cooling system drivers, and/or the like.

Each driver controller element 215 corresponds to an endpoint within the system (e.g., a component of a manipulation source 60, a component of a voltage source 50 (radio frequency voltage sources, arbitrary waveform generators (AWG), direct digital synthesizer (DDS), and/or other waveform generator), a component of a cooling and/or vacuum system, a component of the optics collection system, and/or the like). Each endpoint within the quantum computer 110 represents an individual hardware control. Each endpoint has its own set of accepted micro-commands, in various embodiments. Examples include but are not limited to a voltage source 50 such as a direct digital synthesizer (DDS), component of an optics collection system such as a photomultiplier tube (PMT), a component of a manipulation source 60 such as a laser driver and/or optical modulator switch, and/or general-purpose output (GPO). Individual commands for a DDS allow for setting power level, frequency and phase of a controlling signal generated thereby. Commands for a PMT interface include start/stop photon count and reset of count, in various embodiments. Commands for a GPO endpoint include setting and/or clearing one or more output lines, in various embodiments. These output lines can be used to control external hardware in a manner synchronized with the quantum circuit execution.

In various embodiments, the quantum system controller 30 comprises means for communicating and/or receiving signals from one or more optical receiver components (e.g., of the optics collection system). For example, the quantum system controller 30 may comprise one or more analog-digital (A/D) converter elements 225 configured to receive signals from one or more optical receiver components (e.g., a photodetector of the optics collection system), calibration sensors, and/or the like. In various embodiments, the A/D converter elements 225 are configured to write the input data generated by converting the received signals generated by one or more optical receiver components of the optics collection system to memory 210.

In various embodiments, the quantum system controller 30 may comprise a communication interface 220 for interfacing and/or communicating with, for example, a computing entity 10. For example, the quantum system controller 30 may comprise a communication interface 220 for receiving executable instructions, command sets, and/or the like from the computing entity 10 and providing output received from the quantum computer 110 (e.g., from an optics collection system) and/or the result of a processing the output to the computing entity 10. In various embodiments, the computing entity 10 and the quantum system controller 30 may communicate via a direct wired and/or wireless connection and/or via one or more wired and/or wireless networks 20.

### Example Computing Entity

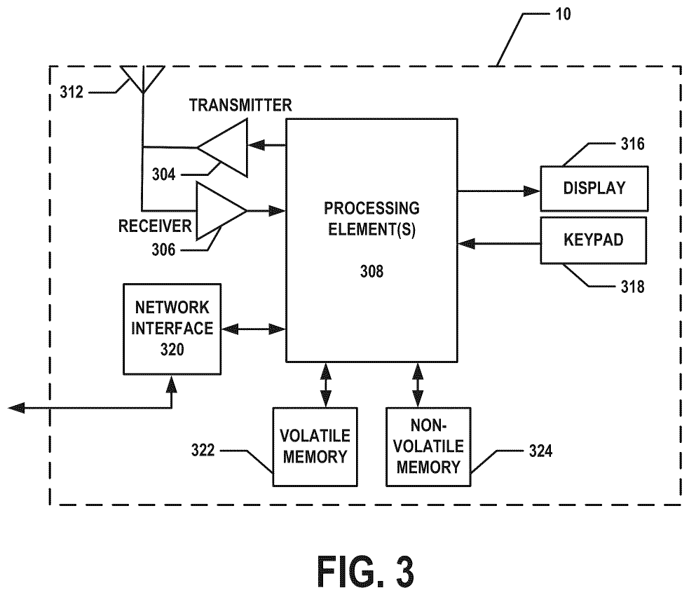

FIG. 3 provides an illustrative schematic representative of an example computing entity 10 that can be used in conjunction with embodiments of the present disclosure. In various embodiments, a computing entity 10 is a classical (e.g., semiconductor-based) computer configured to allow a user to provide input to the quantum computer 110 (e.g., via a user interface of the computing entity 10) and receive, display, analyze, and/or the like output from the quantum computer 110.

As shown in FIG. 3, a computing entity 10 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as a quantum system controller 30, other computing entities 10, and/or the like. The computing entity 10 can include a network interface 320, which may provide signals to and receive signals in accordance with an interface standard of applicable network systems to communicate with various entities, such as a quantum system controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 322 and/or non-volatile storage or memory 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Example Quantization Field Control Circuit

In various embodiments, any suitable circuitry may be used to generate a magnetic field having a selectable magnitude and a selectable direction to act upon an atomic object confinement apparatus. Such circuitry may be termed a quantization field control circuit. For example, as described above, one or more quasi-DC circuits may be arranged to generate a magnetic field having a selectable magnitude and a selectable direction. In various embodiments, the magnitude and the direction of the generated magnetic field are based on the magnitude and the direction of the current flowing through the one or more quasi-DC circuits. In various embodiments, the one or more quasi-DC circuits are lithographically printed circuits on the trap chip (i.e., the chip upon which the atomic object confinement apparatus is manufactured and/or fabricated).

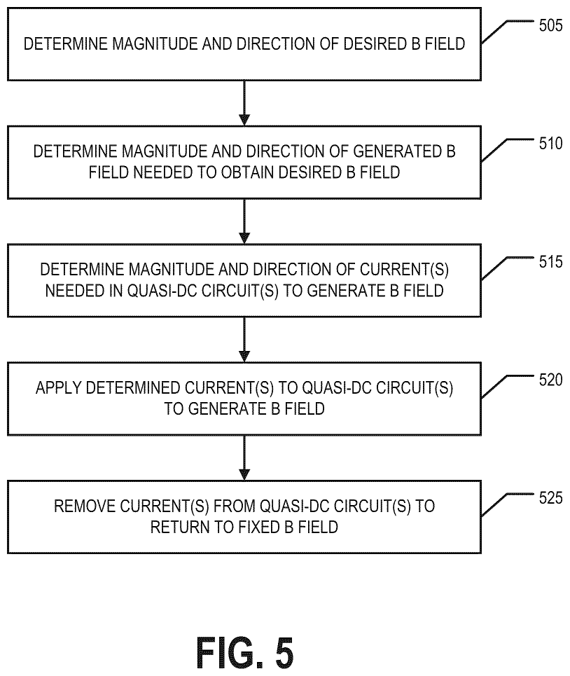

FIGS. 5A-5G illustrate an example quantization field control circuit that comprises three individual quasi-DC circuits. The example quantization field control circuit 400 of FIGS. 5A-5G comprises a first quasi-DC circuit 405, a second quasi-DC circuit 410 that is positioned substantially parallel (not electrically connected in parallel) to the first quasi-DC circuit 405, and a third quasi-DC circuit 415 that is positioned substantially perpendicular to the first quasi-DC circuit 405 and the second quasi-DC circuit 410. The marked position 420 indicates an example position of one or more atomic objects (e.g., ion) relative to the example quantization field control circuit 400. For example, the marked position 420 may be a one or two qubit gate zone at which location logical operations are performed.

The example quantization field control circuit 400 is positioned such that the resulting magnetic field acts upon the desired area of the atomic object confinement apparatus and upon the desired atomic object(s) thereon. Generally, atomic objects are confined about 50 microns above the surface of the atomic object confinement apparatus. As such, the example quantization field control circuit of various embodiments is configured and positioned to generate the desired magnetic field at about 50 microns above the surface of the atomic object confinement apparatus.

In various embodiments, the direction and the magnitude of the quasi-DC current flowing through each of the first, second, and third quasi-DC circuits may be separately selected to control the magnitude and the direction (on an x, y, z coordinate system) of the magnetic field generated by the quasi-DC circuits. In the figures, the x-direction is horizontal on the page, the y-direction is vertical on the page, and the z-direction is perpendicular to the page.

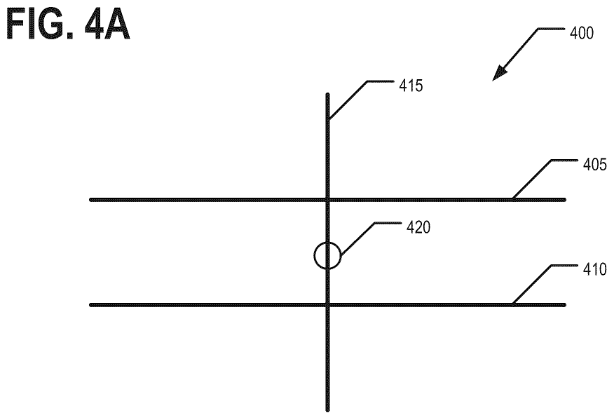

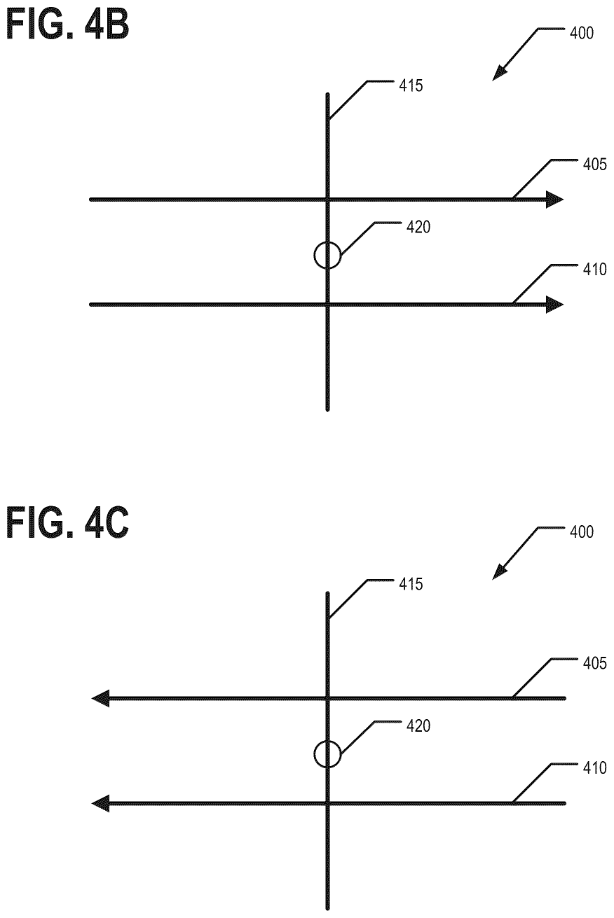

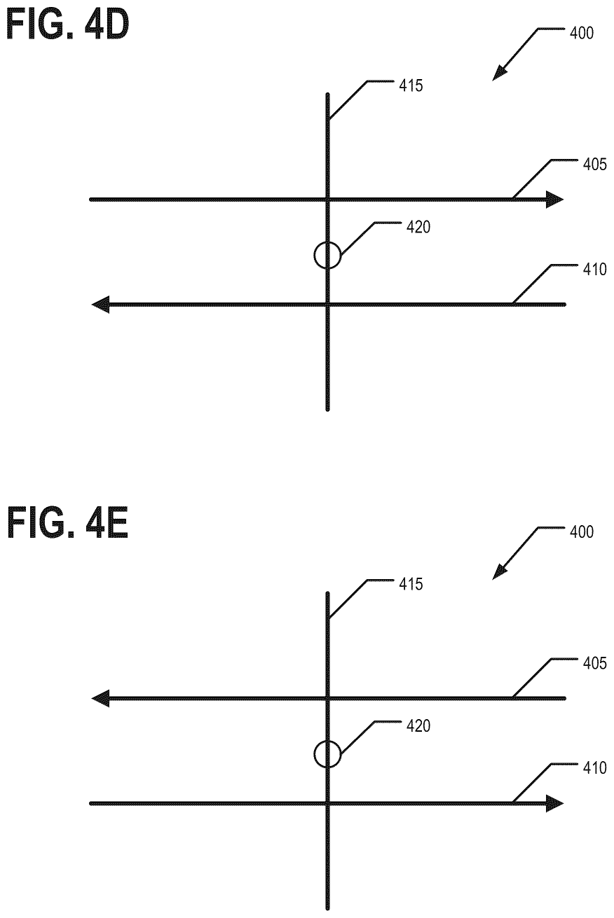

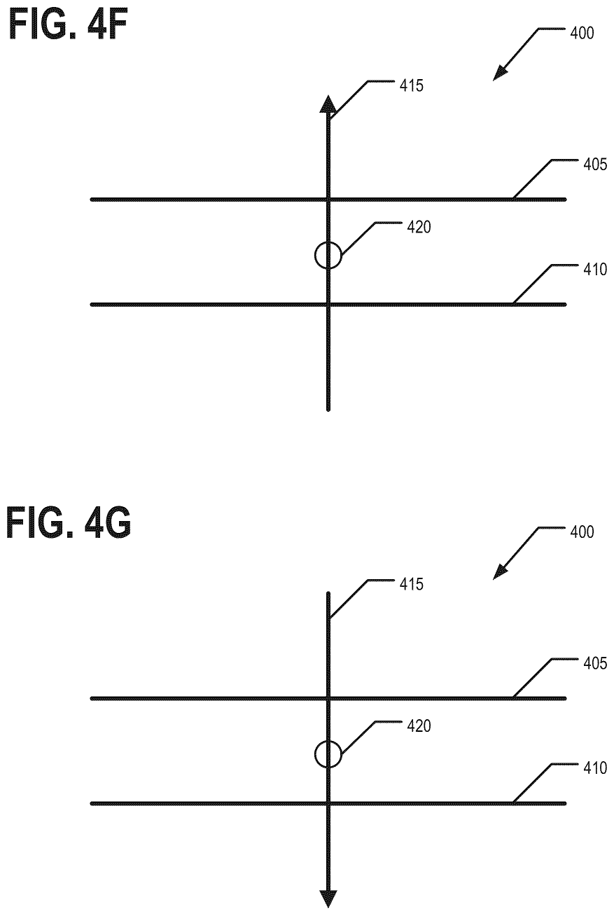

FIG. 4B illustrates an example in which a quasi-DC current is flowing in the same direction through each of the first quasi-DC circuit 405 and the second quasi-DC circuit 410. No current is flowing through the third quasi-DC circuit 415. In the example of FIG. 4B, the generated magnetic field at the desired location (e.g., 50 microns above the atomic object confinement apparatus in the positive z-direction) will be in a negative y-direction. The magnitude of the generated magnetic field is determined by the magnitude of the current flowing through each of the first quasi-DC circuit 405 and the second quasi-DC circuit 410.

FIG. 4C illustrates an example in which a quasi-DC current is flowing in the same direction through each of the first quasi-DC circuit 405 and the second quasi-DC circuit 410, but both in an opposite direction from FIG. 4B. No current is flowing through the third quasi-DC circuit 415. In the example of FIG. 4C, the generated magnetic field at the desired location (e.g., 50 microns above the atomic object confinement apparatus in the positive z-direction) will be in a positive y-direction. The magnitude of the generated magnetic field is determined by the magnitude of the current flowing through each of the first quasi-DC circuit 405 and the second quasi-DC circuit 410.

FIG. 4D illustrates an example in which a quasi-DC current is flowing in opposite directions through each of the first quasi-DC circuit 405 and the second quasi-DC circuit 410. No current is flowing through the third quasi-DC circuit 415. In the example of FIG. 4D, the generated magnetic field at the desired location (e.g., 50 microns above the atomic object confinement apparatus in the positive z-direction) will be in a negative z-direction. The magnitude of the generated magnetic field is determined by the magnitude of the current flowing through each of the first quasi-DC circuit 405 and the second quasi-DC circuit 410.

FIG. 4E illustrates an example in which a quasi-DC current is flowing in opposite directions through each of the first quasi-DC circuit 405 and the second quasi-DC circuit 410, and in opposite directions from FIG. 4D. No current is flowing through the third quasi-DC circuit 415. In the example of FIG. 4E, the generated magnetic field at the desired location (e.g., 50 microns above the atomic object confinement apparatus in the positive z-direction) will be in a positive z-direction. The magnitude of the generated magnetic field is determined by the magnitude of the current flowing through each of the first quasi-DC circuit 405 and the second quasi-DC circuit 410.

FIG. 4F illustrates an example in which a quasi-DC current is flowing through the third quasi-DC circuit 415. No current is flowing through the first quasi-DC circuit 405 or the second quasi-DC circuit 410. In the example of FIG. 4F, the generated magnetic field at the desired location (e.g., 50 microns above the atomic object confinement apparatus) will be in a positive x-direction. The magnitude of the generated magnetic field is determined by the magnitude of the current flowing through the third quasi-DC circuit 415.

FIG. 4G illustrates an example in which a quasi-DC current is flowing through the third quasi-DC circuit 415, but in an opposite direction from FIG. 4F. No current is flowing through the first quasi-DC circuit 405 or the second quasi-DC circuit 410. In the example of FIG. 4G, the generated magnetic field at the desired location (e.g., 50 microns above the atomic object confinement apparatus) will be in a negative x-direction. The magnitude of the generated magnetic field is determined by the magnitude of the current flowing through the third quasi-DC circuit 415.

While FIGS. 4B through 4G illustrate generating magnetic fields in either the x-reaction or the y-direction or the z-direction, in some embodiments the magnitude and direction of the currents through such a quantization field control circuit can be selected to generate a magnetic field whose direction does not fall solely along the x, y, or z axis, but rather which has x and y components, x and z components, y and z components, or x, y, and z components.

In some embodiments in which a fixed magnetic field is present, the magnetic field generated by the quantization field control circuit will combine with the fixed magnetic field as a vector sum. In such embodiments, the magnitude and direction of the currents through the quantization field control circuit are selected such that the combined magnetic field has the desired magnitude and direction.

The B-field falls off as 1/r\hat{ }n, depending on the circuit, where r is the radius from the B-field-producing circuit and n is any integer. Whether or not the impact of the generated B-field at a certain distance is acceptably small depends on the magnitudes of both the main quantization B-field and the localized B-field generated by the circuits. In various embodiments, other qubits not intended to be acted upon by the generated B-field are held in distant enough zones to have an acceptably small impact.

In various embodiments, there may be multiple quantization field control circuits generating multiple magnetic fields at different locations on the atomic object confinement apparatus. In some embodiments, the multiple quantization field control circuits may be configured to each produce a magnetic field having the same magnitude and direction. In some embodiments, the multiple quantization field control circuits may be configured to be able to each produce a different magnetic field (i.e., different magnitude and/or different direction) from each other quantization field control circuit. In some embodiments, there may be multiple quantization field control circuits that produce the same magnetic field and multiple quantization field control circuits capable of producing different magnetic fields. In some embodiments in which multiple quantization field control circuits produce the same magnetic field, such multiple quantization field control circuits may be electrically connected and share the same current. For example, a first quasi-DC circuit of a first quantization field control circuit may be electrically connected to and share a current with a first quasi-DC circuit of a second quantization field control circuit, a second quasi-DC circuit of a first quantization field control circuit may be electrically connected to and share a current with a second quasi-DC circuit of a second quantization field control circuit, and a third quasi-DC circuit of a first quantization field control circuit may be electrically connected to and share a current with a third quasi-DC circuit of a second quantization field control circuit,

In one example embodiment, a current of about 0.1 amp to about 1.0 amp generates a magnetic field of about 4 Gauss to about 40 Gauss at the typical 50 micron distance of the atomic object. In various embodiments, a magnetic field of up to 40 Gauss is typically strong enough to dominate the B-field. That is, magnetic field of up to 40 Gauss is typically strong enough to completely overcome the fixed magnetic field, which is commonly 2-5 Gauss, if desired. Generating a 1.0 amp current is typically possible for integrated circuits without causing damage to the IC.

In various embodiments, quasi-DC circuit/current does not refer to an oscillating current, but rather refer to a current ramping up from no current to a desired DC current when the desired magnetic field is to be generated and down from the desired DC current to no current when the desired magnetic field is no longer needed. Ramping the current up and down slowly enough will tend to avoid introducing transitions and/or memory errors. In various embodiments, the time scale of the ramping should be slow compared to a Zeeman frequency splitting within the hyperfine manifolds. In various embodiments, about ten microseconds for ramping the current (up or down) should be sufficiently slow. In various embodiments, after the B-field has been increased along the current quantization direction, it is possible to increase the B-field components in other directions more quickly. In various embodiments, increasing the magnitude of the B-field without changing the direction typically does not need to be done with as much concern about timing as when the direction is being changed.

FIG. 5 illustrates a flowchart illustrating various processes, procedures, operations, and/or the like, for temporarily changing the quantization field of an atomic object confinement apparatus of a quantum computer.

Starting at step/operation 505, the magnitude and direction of a desired quantization field or B-field of an atomic object confinement apparatus is determined. For example, the quantum system controller 30 of a quantum computer system 100 may determine that the magnitude and/or direction of the B-field should be changed in order to change a relative direction of polarization of a manipulation signal generated by a manipulation source 60. As another example, the quantum system controller 30 of a quantum computer system 100 may determine that the magnitude (but not the direction) of the B-field should be increased for a gating operation to be performed.

At step/operation 510, the magnitude and direction of a B-field to be generated in order to obtain the desired B-field determined at step/operation 505 is determined. For example, the quantum system controller 30 of a quantum computer system 100 may determine, taking into consideration the magnitude and direction of the fixed B-field, what the magnitude and direction of the generated B-field needs to be such that, when the generated B-field is combined with the fixed B-field, the desired B-field determined at step/operation 505 is obtained.

At step/operation 515, the magnitude and direction of one or more currents needed in one or more quasi-DC circuits in order to generate the B-field determined at step/operation 510 is determined. For example, the quantum system controller 30 of a quantum computer system 100 may determine, based on the number and arrangement of the quasi-DC circuits 400, the magnitude and direction of the currents needed in each of the quasi-DC circuits 400.

At step/operation 520, the one or more currents determined at step/operation 515 are applied to the appropriate one(s) of the quasi-DC circuits 400 to generate the B-field determined at step/operation 510.

At step/operation 525, the applied currents are removed when it is desired to return to the fixed B-field.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An atomic object confinement apparatus comprising:
a plurality of electrodes comprising a plurality of radio frequency (RF) rail electrodes, the plurality of RF rail electrodes arranged to define, at least in part, a periodic array of confinement segments, wherein the plurality of RF rail electrodes are configured such that, when an oscillating voltage signal is applied thereto, the plurality of RF rail electrodes generate a pseudopotential in a form of an array of trapping regions configured to contain at least one atomic object within a respective trapping region of the array of trapping regions; and
one or more quasi-direct-current (quasi-DC) circuits arranged to generate a magnetic field having a selectable magnitude and a selectable direction, wherein the generated magnetic field acts on at least one atomic object within the array of trapping regions.

2. The atomic object confinement apparatus of claim 1, wherein the magnitude and the direction of the generated magnetic field are based on a magnitude and a direction of a current flowing through the one or more quasi-DC circuits.

3. The atomic object confinement apparatus of claim 1, wherein the magnitude and the direction of the generated magnetic field are selected based on an operation to be performed.

4. The atomic object confinement apparatus of claim 3, wherein a relatively lower magnitude of the generated magnetic field is selected as a steady-state magnetic field; and
wherein a relatively higher magnitude of the generated magnetic field is selected when a logical operation is to be performed within the array of trapping regions.

5. The atomic object confinement apparatus of claim 1, wherein the generated magnetic field interacts with a preexisting, fixed magnetic field to create a combined magnetic field.

6. The atomic object confinement apparatus of claim 1, wherein the one or more quasi-DC circuits comprise first and second quasi-DC circuits arranged parallel to each other and a third quasi-DC circuit arranged perpendicularly to the first and second quasi-DC circuits.

7. The atomic object confinement apparatus of claim 6, wherein a first current flowing through the first quasi-DC circuit and a second current flowing through the second quasi-DC circuit in a same direction as the first current generates a magnetic field in a y-direction.

8. The atomic object confinement apparatus of claim 6, wherein a first current flowing through the first quasi-DC circuit and a second current flowing through the second quasi-DC circuit in an opposite direction from the first current generates a magnetic field in a z-direction.

9. The atomic object confinement apparatus of claim 6, wherein a current flowing through the third quasi-DC circuit generates a magnetic field in an x-direction.

10. The atomic object confinement apparatus of claim 1, wherein the direction of the generated magnetic field is selected to change a relative direction of polarization of a manipulation signal generated by a manipulation source.

11. The atomic object confinement apparatus of claim 1, wherein each current through a respective one of the one or more quasi-DC circuits ramps up from no current to a desired direct current and ramps down from the desired direct current to no current substantially slower than a Zeeman frequency splitting within a hyperfine manifold associated with the atomic object confinement apparatus.

12. A quantum computer comprising:
an atomic object confinement apparatus comprising:
a plurality of electrodes comprising a plurality of radio frequency (RF) rail electrodes, the plurality of RF rail electrodes arranged to define, at least in part, a periodic array of confinement segments, wherein the plurality of RF rail electrodes are configured such that, when an oscillating voltage signal is applied thereto, the plurality of RF rail electrodes generate a pseudopotential in a form of an array of trapping regions configured to contain at least one atomic object within a respective trapping region of the array of trapping regions; and
one or more quasi-direct-current (quasi-DC) circuits arranged to generate a magnetic field having a selectable magnitude and a selectable direction, wherein the generated magnetic field acts on at least one atomic object within the array of trapping regions;
a voltage source; and
a controller configured to cause the voltage source to generate the oscillating voltage signal.

13. The quantum computer of claim 12, wherein the magnitude and the direction of the generated magnetic field are based on a magnitude and a direction of a current flowing through the one or more quasi-DC circuits.

14. The quantum computer of claim 12, wherein the magnitude and the direction of the generated magnetic field are selected based on an operation to be performed.

15. The quantum computer of claim 14, wherein a relatively lower magnitude of the generated magnetic field is selected as a steady-state magnetic field; and
wherein a relatively higher magnitude of the generated magnetic field is selected when a logical operation is to be performed within the array of trapping regions.

16. The quantum computer of claim 12, wherein the generated magnetic field interacts with a preexisting, fixed magnetic field to create a combined magnetic field.

17. The quantum computer of claim 12, wherein the one or more quasi-DC circuits comprise first and second quasi-DC circuits arranged parallel to each other and a third quasi-DC circuit arranged perpendicularly to the first and second quasi-DC circuits.

18. The quantum computer of claim 12, wherein the direction of the generated magnetic field is selected to change a relative direction of polarization of a manipulation signal generated by a manipulation source.

19. The quantum computer of claim 12, wherein each current through a respective one of the one or more quasi-DC circuits ramps up from no current to a desired direct current and ramps down from the desired direct current to no current substantially slower than a Zeeman frequency splitting within a hyperfine manifold associated with the atomic object confinement apparatus.

20. A method comprising:
causing a quantum object confinement apparatus to confine at least one atomic object, wherein the quantum object confinement apparatus comprises:
a plurality of electrodes comprising a plurality of radio frequency (RF) rail electrodes, the plurality of RF rail electrodes arranged to define, at least in part, a periodic array of confinement segments, wherein the plurality of RF rail electrodes are configured such that, when an oscillating voltage signal is applied thereto, the plurality of RF rail electrodes generate a pseudopotential in a form of an array of trapping regions configured to contain at least one atomic object within a respective trapping region of the array of trapping regions; and
generating a magnetic field via one or more quasi-direct-current (quasi-DC) circuits arranged to generate the magnetic field having a selectable magnitude and a selectable direction, wherein the generated magnetic field acts on at least one atomic object within the array of trapping regions.
